(19) United States
(12) Patent Application Publication
(10) Pub. No.: US 2017/0203265 A1
(43) Pub. Date: Jul. 20, 2017

(54) DEVICE FOR PREPARING A COSMETIC PRODUCT FROM A CARTRIDGE, AND SUITABLE CARTRIDGE

(71) Applicant: Rodolphe POUZET, Angoulins (FR)

(72) Inventor: Rodolphe POUZET, ANGOULINS (FR)

(21) Appl. No.: 15/326,840

(22) PCT Filed: Jul. 16, 2015
(86) PCT No.: PCT/FR2015/051953

§ 371 Date: Jan. 17, 2017

(30) Foreign Application Priority Data
Jul. 17, 2014 (FR) 1456885

(51) Int. Cl. B01F 3/08; A45D 40/24; B01F 15/00; A45D 34/00; B01F 7/20; A45D 40/18; A45D 40/00

(52) U.S. Cl. CPC B01F 3/0853; A45D 40/18; A45D 40/24; A45D 40/0068; A45D 34/00; B01F 7/20; B01F 15/00123; A45D 2034/005; B01F 2215/0031

(57) ABSTRACT

Disclosed is a device for preparing a cosmetic product, in the form of a cream, an emulsion, a lotion, a gel, a suspension, a mask or a gommage, in a first container from a base and at least one excipient. The device includes: the first container intended to contain the prepared cosmetic product, including: a free end that is open at the top and equipped with a connector, and a free end that is open at the bottom and equipped with a connector, a cartridge equipped with a connection to the free end, containing the base, an agitator, with a connection to the free end, open at the top, and at least one supply unit collaborating with at least one reservoir.

This invention relates to a device for the preparation of a cosmetic product from a cartridge whether it is in the form of a cream, an emulsion, a lotion. The invention also covers the suitable cartridge.

The cosmetic products are used more and more, with the appearance often being increasingly elaborate for life in society.

In addition, the cosmetic products also make it possible to compensate for and to limit the impacts of stress, pollution, the effects of sunlight, and the effects of time.

There are a large number of products that have the target effectiveness, and the market has become extremely large, no longer being limited to women but in contrast encompassing adolescents and men.

In general, these cosmetic products have plant origins but increasingly marine origins, and are even obtained from exotic sources. The consumers have also noticed that certain products, poorly designed and manufactured by unscrupulous companies, contained allergenic products, toxic products, and at least ineffective products.

In addition, the industrial products are produced in advance and should have aspects and textures that are perfect, constant, and reproducible.

It therefore must be necessary to add, in addition to cosmetic active ingredients, products for preservation and/or stabilization.

In addition, the consumers increasingly seek to have products that totally correspond to them.

The current tendency is therefore increasingly to have recourse to “home-made” and to “custom-made.”

The cosmetics are also subject thereto.

Nevertheless, the industrial methods are complex and require production lines of great complexity that it is impossible to reproduce on a very small scale for domestic uses, by private individuals.

Manufacturers have much greater constraints than private individuals, in particular the perfect reproducibility for using a product of identical presentation, regardless of the site, regardless of the conditions of shipping, preservation, and the time period between the manufacturing and the sell-by or use-by date.

At home, the constraints are fewer because the product is already on site and is not subject to any shipping.

The product that is obtained must have a good consistency and is not subject to vagaries of significant temperature fluctuations.

The constraints are thereby much less significant.

The necessary adjuvants can be greatly limited.

The advantages are therefore numerous.

The cost is also an important component since the industrial products are finished products in their packaging for sale and use.

The volume that is to be shipped is large.

Likewise, the packaging is only very rarely reusable and reused in cosmetics.

The cosmetic products, marketed by manufacturers, are very numerous to be able to meet the different needs. It is inconceivable to manufacture industrially products on demand, in a volume adapted to the needs of a private individual, with a domestic use.

There are machines of the prior art that make it possible to produce cosmetic compositions—in particular the patent application EP 1 813 335—but it is more a matter of an extraction from compounds contained in a capsule by injecting a pressurized fluid, with this machine being similar to a percolator.

The cosmetic compositions should come in the form of an emulsion, a cream, milk; therefore, it is advisable to be able to offer a cosmetic form and not only to carry out an extraction of active ingredients.

The patent application EP 1 221 419 also describes a first container with a first composition and a second container with a second preparation, connecting means between the two containers to ensure a mixing of the two contents in such a way as to obtain the desired final composition.

The object of this invention is a device that makes it possible to produce preparations of cosmetic products, on demand, by limiting the adjuvants by eliminating constraints associated with shipping and with storage conditions, by eliminating the postage associated most of the time with the shipping of the excipient, often by water, by offering a very fast production that is not subject to any industrial polluting environment.

In addition, the composition can be offered in the form of cartridges and produced on demand.

The cartridges can be preserved with no problem over long periods.

The cost is inevitably lower, and the user also has the pleasure of seeing the manufacturing of the product and contributing to it.

The device for preparing a cosmetic composition is now described in detail according to a particular, nonlimiting, embodiment, relative to the accompanying drawings, drawings in which the various figures show:

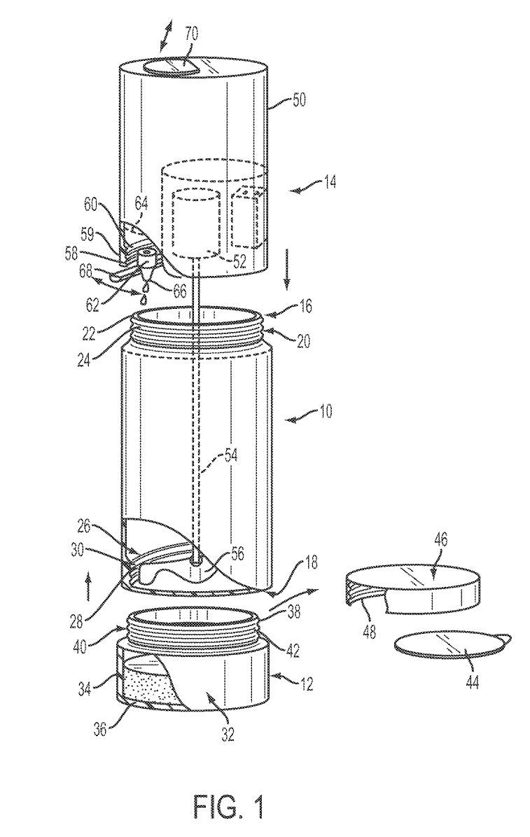

FIG. 1: an exploded perspective view of the device according to this invention with its associated cartridge,

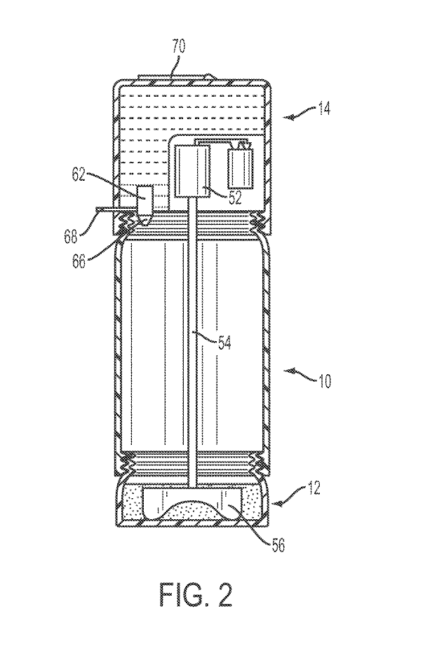

FIG. 2: a cutaway view, by a vertical plane, of the device of FIG. 1, after assembly,

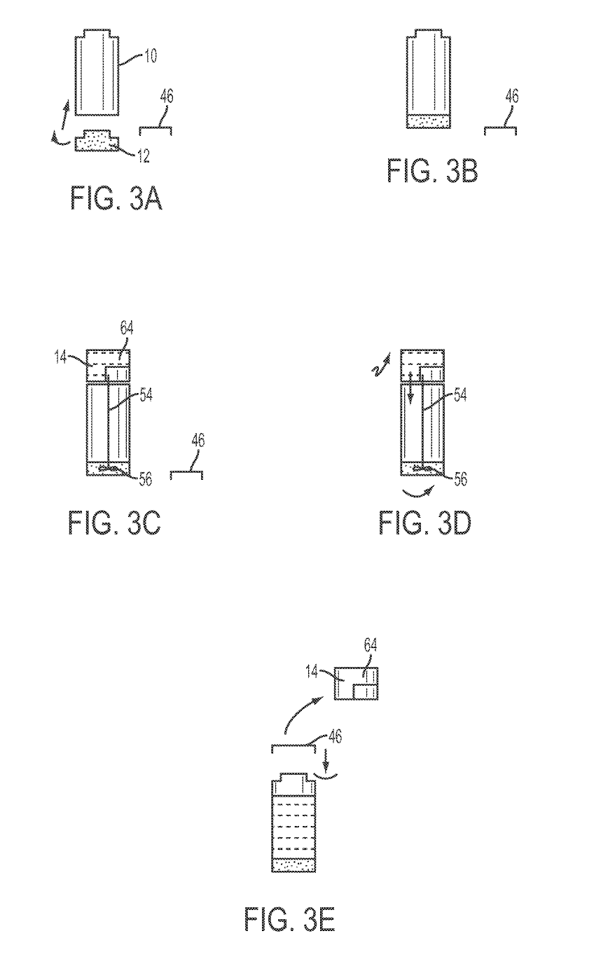

FIGS. 3A to 3E: a block diagram view of the use of the device.

This invention therefore has as its object a device for preparing a cosmetic product, in the form of a cream, an emulsion, a lotion, a gel, a suspension, a mask, or an exfoliating scrub, in a first container 10 from a base and at least one excipient, comprising:
Said first container 10 intended to contain said prepared cosmetic product, comprising:
   A free end 16, open in the upper part, equipped with connecting means 20, and
   A free end 18, open in the lower part, equipped with connecting means 26,
A cartridge 12 that is equipped with means 40 for connecting to said free end 18, containing said base,
Stirring means 14, with means 59 for connecting to said free end 16, open in the upper part, and
At least one supply means 62 working with at least one reservoir 64.

Another object of the invention relates to a cartridge 12 for adapting to said device.

Another object of the invention consists of a connecting system of said device.

Other objects, characteristics, aspects, and advantages of the invention will also appear more clearly from reading the description and examples that follow.

In the following, and unless there is another indication, the limits of a range of values are encompassed in this range, in particular in the expressions “encompassed between” and “ranging from.”

In the following, the expression “at least one” is equivalent to “one or more.”

The preparation device according to this invention, in considering FIGS. 1 and 2, comprises a first container 10, a cartridge 12, and mechanical stirring means 14.

The first container 10 is advantageously cylindrical in shape. It is initially empty and comprises a free end 16, open in the upper part, and a free end 18, open in the lower part.

The free end 16 in the upper part comprises connecting means 20 that are intended to work with the stirring means 14.

These connecting means 20 can consist of a neck 22 that is equipped with an outside threading 24, therefore a male threading.

The free end 18 of the lower part comprises connecting means 26 that are intended to work with a cartridge 12.

These connecting means 26 can consist of a foot 28 that is equipped with an inside threading 30, therefore a female threading.

The cartridge 12 contains a cosmetic base.

The base that can be used in the cosmetic product according to the invention can be selected from among at least one active ingredient, at least one excipient, at least one adjuvant, at least one additive, and/or the mixtures thereof.

The concentration of the base in the cosmetic product according to this invention is between 1 and 99% by weight, preferably between 1 and 50% by weight, and even more preferably between 1 and 30% by weight, in relation to the total weight of the cosmetic product.

In terms of this invention, “active” is defined as an isolated substance or a mixture of substances of natural or synthetic origin that imparts specificity to a finished cosmetic product. It imposes a property on the cosmetic product and determines its nature and its target.

The base according to the invention can contain one or more active ingredients, such as, for example, anti-aging agents, plumping-up agents, antiperspirant agents, free anti-radical agents, hydrating agents, emollients, softening agents, vitamins, or provitamins such as panthenol, cellular antioxidant agents, oily extracts, plants, hydroalcoholic extracts, essential oils, anti-seborrheic agents, mattifying agents, antimicrobial agents, astringents, purifying agents, healing agents, keratoregulating agents, occluding agents, protectors, replenishing creams, soothing agents, decongestants, solar filters, proteins, covering agents, moisturizers, hygroscopic agents, solidifiers, exfoliants, regenerators, firming agents, tightening agents, anti-glycation agents, estrogen-like agents, bactericides, sequestering agents, anti-dandruff agents.

The active ingredient(s) is/are preferably present in proportions that range from 0 to 80% by weight, preferably from 1 to 50% by weight, and more preferably from 5 to 30% by weight, in relation to the total weight of the base.

In terms of this invention, “excipient” is defined as any substance other than the active ingredient that is contained in the cosmetic. Its addition is intended to impart a given consistency or other particular physical characteristics to the final product, while avoiding any interaction, particularly chemical, with the active ingredient.

The base according to the invention can contain one or more excipients, such as, for example, oils, water, alcohols, aqueous extracts, oily extracts, oily maceration products, floral waters, hydrolyzate, fruit juices, vegetable butters, hydroalcoholic extracts, waxes, milk, fruit waters.

The excipient(s) is/are preferably present in proportions that range from 1 to 99% by weight, preferably from 1 to 50% by weight, and more preferably from 1 to 30% by weight, in relation to the total weight of the base.

In terms of this invention, “adjuvant” is defined as any additive that is intended to reinforce the properties of a substance or to facilitate its manufacture.

The base according to the invention can contain one or more adjuvants, such as, for example, preservatives, stabilizing agents, surfactants, acidifying agents, alkalinizing agents, thickening agents, co-thickening agents, penetrating agents, plasticizers, buffers, ceramides, pseudo-ceramides, opacifying agents, reducing agents, emulsifiers, texture agents, polymers, solubilizers, foaming agents, anti-foaming agents, antioxidants, and any other additive that is conventionally used in the cosmetic field.

One skilled in the art will ensure that the adjuvant or adjuvants and quantities thereof will be selected in such a way that they will not impair the properties of the cosmetic product of this invention.

The adjuvant(s) is/are preferably present in proportions that range from 1 to 99% by weight, preferably from 1 to 80% by weight, and more preferably from 1 to 50% by weight, in relation to the total weight of the base.

In terms of this invention, “additive” is defined as a liquid substance or a powder, introduced for providing or improving one or more specific properties.

The base according to the invention can contain one or more additives, such as, for example, perfumes, dyes, mineral feedstocks, pearls, flakes, clays, exfoliants.

One skilled in the art will ensure that the possible additives and quantities thereof will be selected in such a way that they do not impair the properties of the cosmetic product of this invention.

The additive(s) is/are preferably present in proportions that range from 0 to 50% by weight, preferably from 1 to 20% by weight, in relation to the total weight of the base.

The cartridge 12 comprises connecting means 40 that are designed to work with the first container 10.

These connecting means 40 can consist of an opening 38 that is equipped with an outside threading 42, therefore a male threading.

The connecting means 40 of the cartridge 12 and the connecting means 26 of the free end 18, open on the lower part of the first container 10, are respectively male and female threadings.

In a preferred manner, the cartridge 12 is cylindrical in shape, and the outside diameter of said cartridge 12 is equal or approximately equal to the outside diameter of the body of the first container 10, in such a way as to have continuity when said cartridge 12 is connected to said first container 10, as can be seen in FIG. 2.

In another embodiment, said connecting means 40 are intended to work with a cap 46.

The cap 46 is equipped with an inside threading 48, therefore a female threading.

The cartridge 12 also comprises a second container 32 with a body 34, a bottom 36, and an opening 38.

When it is not connected to the first container 10, the cartridge 12 can be connected to the cap 46 and/or to a lid 44.

Before the connection between said first container 10 and said cartridge 12, said cartridge 12 comprises a lid 44 and/or a cap 46.

The lid 44 is a membrane that is generally connected in an airtight way to the upper peripheral edge of the opening 38 of the second container 32 of the cartridge, which prevents the contact of the contents of the cartridge with the air, therefore with the oxygen for the products that are sensitive to oxidation, and in any case with the pollutants of the air.

The cap 46 is equipped with an inside threading 48, therefore a female threading, provided for working with the outside, therefore male, threading 42, of the connecting means 40 of the opening 38.

The cap 46 generally comprises a sealing joint, not shown, but completely familiar, under the upper face of said cap 46, which ensures the sealing with the upper peripheral edge of the opening 38 of the second container 32 of the cartridge 12.

The stirring means 14 can be of the electrical, mechanical, pneumatic, or manual type.

Preferably, said stirring means 14 comprise a housing 50 that comprises a motor 52 and its power supply, a shaft 54, and a blade 56.

The stirring means 14 comprise a housing 50 that comprises a motor 52 with its power supply, which drives a shaft 54 whose end carries a blade 56.

The stirring means 14 comprise connecting means 59 that are intended to work with the first container 10.

These connecting means 59 can consist of a collar 58 that is equipped with an inside threading 60, therefore a female threading.

The connecting means 20 of the free end 16, open in the upper part of the first container 10, and the connecting means 59 of the stirring means 14 are respectively male and female threadings.

In a preferred manner, the stirring means 14 are cylindrical in shape, and the outside diameter of said stirring means 14 is equal or approximately equal to the outside diameter of the body of the first container 10, in such a way as to have continuity when said stirring means 14 are connected to said first container 10, as can be seen in FIG. 2.

In another embodiment, said connecting means 20 are intended to work with the cap 46.

Advantageously, the cartridge 12, the first container 10, and the stirring means 14 are cylindrical in shape.

According to a preferred embodiment of the invention, the outside diameter of said stirring means 14 is equal or approximately equal to the outside diameter of the body of the first container 10, and the outside diameter of said cartridge 12 is equal or approximately equal to the outside diameter of the body of the first container 10, in such a way as to have continuity when said stirring means 14 and said cartridge 12 are connected to said first container 10, as can be seen in FIG. 2.

In an advantageous way, the housing 50 comprises the collar 58, which is equipped with connecting means 59 of an inside threading 60, therefore a female threading, intended to work with the male threading 24 of the neck 22 of the connecting means 20 of the first container 10.

The shaft 54 is positioned in the housing 50 in such a way as to come in an essentially coaxial way to the first container 10 when said housing 50 is mounted on the first container 10, as can be seen in FIG. 2.

In terms of this invention, “essentially coaxial” is defined as the fact that the shaft 54 and the first container 10 have axes that are parallel and/or have an angular displacement of less than one degree, and more particularly of less than 0.5 degree.

Preferably, the shaft 54 is connected to the stirring means 14.

According to an advantageous embodiment, the shaft 54 is positioned in the housing 50 in such a way as to be coaxial to the first container 10 when said housing 50 is mounted on the first container 10.

In a first embodiment, the shaft 54 can be detached from the housing 50.

In a second embodiment, the blade 56 can be detached from the shaft 54.

The length of the shaft 54 is such that, when the stirring means 14 are in place, the blade 56 carried by said shaft 54 comes into the immediate proximity of the bottom 36 of the cartridge 12.

The blade 56 has a profile that is suited to the use and the function of the product to be obtained, by taking into consideration the starting composition. The blade 56 can be a multiple unit and can also comprise several blades.

An example that is shown in FIG. 2 is provided by way of indication.

As explained above, the device also comprises at least one supply means 62 that works with at least one reservoir 64.

According to a particular embodiment, the at least one supply means 62 that works with at least one reservoir 64 is a means for supplying an excipient, i.e., comprises at least one excipient.

In this first embodiment, the at least one supply means 62 can also contain at least one active ingredient, at least one adjuvant, at least one additive, and/or mixtures thereof.

According to another embodiment of the invention, the at least one supply means 62 that works with at least one reservoir 64 is a means for supplying an active ingredient, i.e., comprises at least one active ingredient.

In this second embodiment, the at least one supply means 62 can also contain at least one excipient, at least one adjuvant, at least one additive, and/or mixtures thereof.

In these two embodiments, said at least one active ingredient, at least one excipient, at least one adjuvant, and at least one additive are as defined above and can be found in the base that can be used in the cosmetic product according to the invention.

The at least one supply means 62 can comprise at least one reservoir 64 that can be connected to the housing 50 or that is an integral part of said housing 50 and removable as shown in FIG. 3.

In a particular embodiment of the invention, the device comprises at least one supply means 62, with said at least one supply means 62 being combined with one or more reservoirs 64.

Preferably, said at least one supply means 62 is combined with a single reservoir 64.

The at least one supply means 62 can be integrated with the stirring means 14.

The reservoir 64 comprises at least one tap 66, emptying into the first container 10, and at least one flow control means 68.

The at least one tap 66 empties into the first container 10, in particular close to the shaft 54.

The at least one flow control means 68, for example in the form of an adjustable valve, makes it possible to manage the rate of this flow. Advantageously, said valve can assume multiple positions that correspond to preadjusted flow rates.

The at least one flow control means 68 can be mechanical, electrical, pneumatic, and/or manual.

In a particular embodiment of the invention, the device comprises at least one supply means 62, each said at least one supply means 62 comprising a tap 66 and a flow control means 68, and being combined with one or more reservoirs 64.

Preferably, said at least one supply means 62 comprises a tap 66 and a flow control means 68 and is combined with a single reservoir 64.

The reservoir 64 ultimately comprises at least one cover 70 for allowing access and ensuring filling.

In a preferred manner, each reservoir 64 comprises at least one cover 70, and preferably a single cover 70.

Of course, the device can also be equipped with numerous additional elements that have not been shown in the figures for the sake of simplification.

The use of the device that was just described is shown in FIGS. 3 through a block diagram.

In FIG. 3A, this block diagram shows the installation of the cartridge 12 on the first container 10 after removing the cap 46 and/or the lid 44.

The cartridge is therefore attached in an airtight way to the first container 10; see FIG. 3B.

It is then advisable to connect the stirring means 14; see FIG. 3C. The blade 56 and the shaft 54 pass through the upper opening 16 of the first container 10 and extend into the cartridge 12 and into its contents.

Once in place, in FIG. 3D, the motor 52 is activated and, simultaneously, the liquid or the powder that is contained in the reservoir 64 flows through the at least one supply means 62, with this flow being regulated by the flow control means 68.

The liquid or the powder that is contained in the reservoir 64 can comprise at least one active ingredient, at least one excipient, at least one adjuvant, at least one additive and/or the mixtures thereof.

According to the rotation speed, the flow and the contents of the cartridge, the contents of the reservoir, the user obtains the desired cosmetic product in the form of an emulsion, a suspension, a cream, a gel, a lotion, a mask, or an exfoliating scrub.

It is then sufficient to remove the stirring means 14 and to place the cap 46 on the first container 10; see FIG. 3E. Actually, in an advantageous way, the threadings of the different connecting means 20, 26, 40, 59 are compatible.

The user therefore has a first container 10 with the cosmetic product inside it.

After the contents of the first container 10 have been used, the user, wanting to produce the same product or another product, initiates the cleaning of said first container 10 after having removed the cartridge.

He then attaches another cartridge with an identical or different base and initiates the same implementation.

The liquid or the powder can be contained in the reservoir 64 in the improved embodiment of the invention, but the reservoir can also be eliminated, and the liquid or the powder is then directly introduced into the first container 10 after the installation of the cartridge.

The liquid or powder concentration that can be contained in the reservoir 64 or that can be directly introduced into the first container 10 is between 1 and 99% by weight, preferably between 1 and 50% by weight, and even more preferably between 1 and 70% by weight, in relation to the total weight of the cosmetic product.

In a particular embodiment of the invention, the device according to the invention is a connected object that makes it possible for the user himself to prepare the cosmetic product according to the invention.

This preparation is made by the selection of various ingredients based on the user's skin type.

In terms of this invention, “ingredient” is defined as said active ingredient, excipient, adjuvant, and additive, as defined above and that can be found in the base that can be used in the cosmetic product according to the invention.

According to a first alternative of the invention, said connected device comprises at least one sensor.

The sensor receives, for example, the data from a smartphone or a tablet and sends a signal to the flow control means 68, making possible a controlled and suitable flow of the liquid or powder contained in the reservoir or reservoirs.

The connection between the device according to the invention and the smartphone or tablet can be ensured in various ways, such as, for example, by using a cable, a bluetooth connection, or a WIFI connection.

According to a second alternative of the invention, said connected device comprises at least one screen.

The screen makes it possible for the user, via an application on his smartphone or his tablet, to select and to quantify the ingredient or ingredients.

The connection between the device according to the invention and the smartphone or tablet can be ensured by using a cable, a bluetooth connection, or a WIFI connection.

In another embodiment of the invention, the device according to the invention is not a connected object.

According to this alternative, the user himself can select the ingredient or ingredients that constitute(s) the cosmetic product.

The user can either select the ingredients according to the research that he will have carried out via an application on his smartphone or his tablet or can enjoy a greater freedom by choosing the ingredient or ingredients and the quantities thereof himself.

The preferred embodiment that was just described comprises threadings, but these threadings could be replaced by any technically or mechanically equivalent means, such as clamp-type connecting means, without thereby modifying this invention.

The first container 10, the cartridge 12, the reservoir 64 can advantageously be made of plastic material, metal, preferably stainless steel, ceramic, resin, or a mixture of these materials, with these materials having to meet food and cosmetic standards.

Another object of the invention relates to a cartridge 12 for adapting to the device according to the invention.

Said cartridge 12 comprises a second container 32 with a body 34, a bottom 36, and an opening 38 that is equipped with a lid 44 and/or a cap 46.

The invention also relates to the use of the device according to the invention.

The invention also applies to the use of a connecting system of said device.

1. Device for preparing a cosmetic product, in the form of a cream, an emulsion, a lotion, a gel, a suspension, a mask, or an exfoliating scrub, in a first container (10) starting from a base and at least one excipient, comprising:
Said first container (10) intended to contain said prepared cosmetic product, comprising:
A free end (16), open in the upper part, equipped with connecting means (20), and
A free end (18), open in the lower part, equipped with connecting means (26),
A cartridge (12) that is equipped with means (40) for connecting to said free end (18), containing said base,
Stirring means (14), with means (59) for connecting to said free end (16), open in the upper part, and
At least one supply means (62) working with at least one reservoir (64).

2. Device for preparing a cosmetic product according to claim 1, wherein the stirring means (14) are of the electrical, mechanical, pneumatic, or manual type.

3. Device for preparing a cosmetic product according to claim 1, wherein the connecting means (20) of the free end (16), open in the upper part of the first container (10), and the connecting means (59) of the stirring means (14) are respectively male and female threadings.

4. Device for preparing a cosmetic product according to claim 1, wherein the connecting means (40) of the cartridge (12) and the connecting means (26) of the free end (18), open in the lower part of the first container (10), are respectively male and female threadings.

5. Device for preparing a cosmetic product according to claim 1, wherein the at least one supply means (62) is a means for supplying an excipient.

6. Device for preparing a cosmetic product according to claim 5, wherein the means for supplying an excipient also contains at least one active ingredient, at least one adjuvant, at least one additive, and/or the mixtures thereof.

7. Device for preparing a cosmetic product according to claim 1, wherein the at least one supply means (62) is a means for supplying an active ingredient.

8. Device for preparing a cosmetic product according to claim 7, wherein the means for supplying an active ingredient also contains at least one excipient, at least one adjuvant, at least one additive, and/or the mixtures thereof.

9. Device for preparing a cosmetic product according to claim 1, wherein the reservoir (64) comprises at least one tap (66), emptying into the first container (10), and at least one flow control means (68).

10. Device for preparing a cosmetic product according to claim 1, wherein said at least one supply means (62) is integrated with stirring means (14).

11. Device for preparing a cosmetic product according to claim 1, wherein it is a connected object and comprises at least one sensor.

12. Device for preparing a cosmetic product according to claim 1, wherein it is a connected object and comprises at least one screen.

13. Cartridge (12) for adapting to the device according to claim 1, further comprising a second container (32) with a body (34), a bottom (36), and an opening (38) that is equipped with a lid (44) and/or a cap (46).

14. A method for preparing a cosmetic product comprising steps of:
providing the device of claim 1, and
using the device in an appropriate way to produce the cosmetic product.

15. A method for preparing a cosmetic product comprising steps of:
providing the device of claim 1, and
appropriately using a connecting system of the device to produce the cosmetic product.

16. Device for preparing a cosmetic product according to claim 2, wherein the connecting means (20) of the free end (16), open in the upper part of the first container (10), and the connecting means (59) of the stirring means (14) are respectively male and female threadings.

17. Device for preparing a cosmetic product according to claim 2, wherein the connecting means (40) of the cartridge (12) and the connecting means (26) of the free end (18), open in the lower part of the first container (10), are respectively male and female threadings.

18. Device for preparing a cosmetic product according to claim 3, wherein the connecting means (40) of the cartridge (12) and the connecting means (26) of the free end (18), open in the lower part of the first container (10), are respectively male and female threadings.

19. Device for preparing a cosmetic product according to claim 5, wherein said at least one supply means (62) is integrated with stirring means (14).

20. Device for preparing a cosmetic product according to claim 2, wherein it is a connected object and comprises at least one sensor.
